(19) United States
(12) Patent Application Publication
(10) Pub. No.: US 2015/0210796 A1
(43) Pub. Date: Jul. 30, 2015

(54) Novel Compound, Novel Polymer, Colorant Including the Same, Positive Photosensitive Resin Composition Including the Same, and Color Filter

(71) Applicant: Samsung SDI Co., Ltd., Yongin-si (KR)

(72) Inventors: Won-Jung KIM, Suwon-si (KR); Kyoung-Hee KANG, Suwon-si (KR); Chae-Won PAK, Suwon-si (KR); Myoung-Youp SHIN, Suwon-si (KR); Hwan-Sung CHEON, Suwon-si (KR); Eui-Soo JEONG, Suwon-si (KR); Ki-Wook HWANG, Suwon-si (KR)

(21) Appl. No.: 14/520,476

(22) Filed: Oct. 22, 2014

(30) Foreign Application Priority Data
Jan. 28, 2014 (KR) 10-2014-0010619

(51) Int. Cl. C08F 224/00; G02B 1/04; G02B 5/23; C08G 18/38

(52) U.S. Cl. CPC C08F 224/00; C08G 18/3861; G02B 1/04; G02B 5/23

(57) ABSTRACT

Disclosed are a compound represented by the following Chemical Formula 1, wherein in Chemical Formula 1, each substituent is the same as defined in the detailed description, a polymer, a colorant including the same, and a photosensitive resin composition including the colorant, and a color filter.

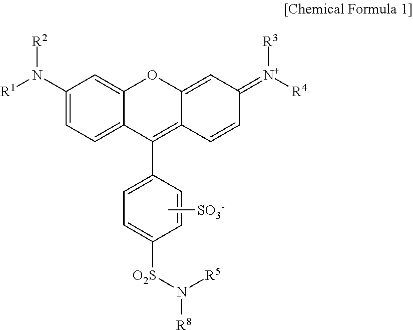

### CROSS-REFERENCE TO RELATED APPLICATION

This application claims priority to and the benefit of Korean Patent Application No. 10-2014-0010619 filed in the Korean Intellectual Property Office on Jan. 28, 2014, the entire disclosure of which is incorporated herein by reference.

### FIELD OF THE INVENTION

This disclosure relates to a novel compound, a novel polymer, a colorant including the same, a photosensitive resin composition including the same, and a color filter.

### BACKGROUND

Optical display device industries have been developed toward realization of a high contrast ratio and high luminance and thus provision of a display having more clarity and high quality with a low cost.

A conventional color filter uses a pigment dispersion as a colorant. Non-uniformity between the pigment and a photoresist composition can deteriorate a contrast ratio of the color filter. In addition, the conventional pigment has a limited chromophore structure and thus it can be difficult to realize various colors and improve transmittance at a particular color.

Accordingly, there have been efforts to overcome these problems by introducing a dye-type colorant, and there is a need to develop a dye-type material having excellent color characteristics and simultaneously good solubility and satisfactory reliability.

### SUMMARY

One embodiment provides a novel compound that can have excellent heat resistance and solubility, a high color transmittance and a high contrast ratio.

Another embodiment provides a novel polymer.

Yet another embodiment provides a colorant including the compound.

Still another embodiment provides a photosensitive resin composition including the colorant.

A further embodiment provides a color filter manufactured from the photosensitive resin composition.

One embodiment provides a compound represented by the following Chemical Formula 1:

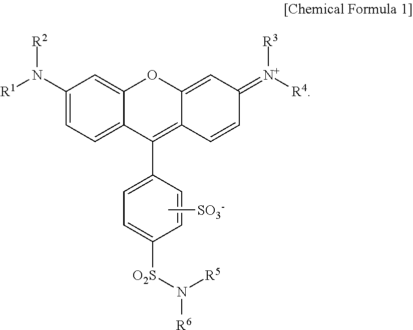

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 2:

*-LX—Y—Z)ₙ. [Chemical Formula 2]

In the above Chemical Formula 2,

L is a single bond, a divalent or trivalent aliphatic organic group, or a divalent or trivalent alicyclic organic group,

X is a single bond, substituted or unsubstituted C1 to C20 alkylene, substituted or unsubstituted C3 to C20 cycloalkylene, or substituted or unsubstituted C6 to C20 arylene,

Y is a single bond, —O—, —C(═O)—, —C(═O)R′—, —OR″—, —R″O— or —OC(═O)NHR′″—, wherein R′ to R′″ are the same or different and are each independently substituted or unsubstituted C1 to C20 alkylene, substituted or unsubstituted C3 to C20 cycloalkylene, or substituted or unsubstituted C6 to C20 arylene,

Z is a substituted or unsubstituted acrylate group, a substituted or unsubstituted amine group, an isocyanate group, a hydroxy group, substituted or unsubstituted C1 to C20 alkyl or —OC(═O)R″″, wherein R″″ is substituted or unsubstituted C1 to C20 alkyl, and

n is an integer of 1 or 2.

R⁵ and R⁶ may both be represented by the above Chemical Formula 2.

The above Chemical Formula 2 may be represented by one or more of the following Chemical Formula 3 to Chemical Formula 6:

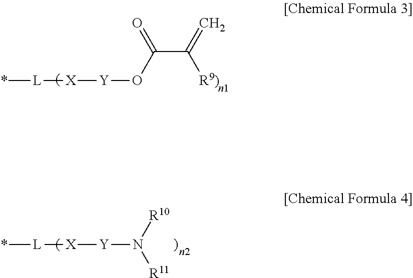

*-LX—Y—NCO)ₙ₃ [Chemical Formula 5]

*-LX—Y—OH)ₙ₄. [Chemical Formula 6]

In the above Chemical Formula 3 to Chemical Formula 6,

L is a single bond, a divalent or trivalent aliphatic organic group, or a divalent or trivalent alicyclic organic group,

X is a single bond, substituted or unsubstituted C1 to C20 alkylene, substituted or unsubstituted C3 to C20 cycloalkylene, or substituted or unsubstituted C6 to C20 arylene,

Y is a single bond, —OR″— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene,

R⁹ to R¹¹ are the same or different and are each independently hydrogen or substituted or unsubstituted C1 to C20 alkyl, and

n1 to n4 are the same or different and are each independently integers of 1 or 2.

In addition, the above Chemical Formula 2 may be represented by one or more of the following Chemical Formula 7 to Chemical Formula 10:

*-L(CH₂)ₘ₁—CH₃)ₙ₅ [Chemical Formula 7]

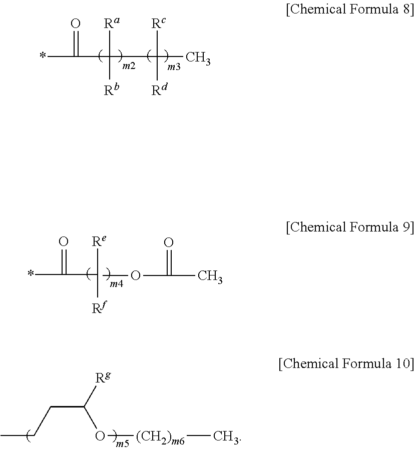

In the above Chemical Formula 7 to Chemical Formula 10,

L is a single bond, a divalent or trivalent aliphatic organic group, or a divalent or trivalent alicyclic organic group,

R^{a} to R^{g} are the same or different and are each independently hydrogen or substituted or unsubstituted C1 to C20 alkyl,

n5 is an integer of 1 or 2,

m1 to m4, and m6 are the same or different and are each independently integers ranging from 0 to 15, and

m5 is an integer ranging from 1 to 5.

Another embodiment provides a polymer formed by a copolymerization reaction of the compound and a monomer.

The monomer may be selected from an ethylenic unsaturated monomer, an isocyanate monomer, an alcohol monomer, and a combination thereof.

The ethylenic unsaturated monomer may be selected from an aromatic vinyl compound, an unsaturated carboxylate ester compound, an unsaturated amino alkyl carboxylate ester compound, a vinyl carboxylate ester compound, an unsaturated carboxylic acid glycidyl ester compound, a vinyl cyanide compound, an unsaturated amide compound, and a combination thereof.

The polymer may be an acrylic polymer.

The acrylic polymer may be formed by a copolymerization reaction of a compound represented by the following Chemical Formula 1 and an ethylenic unsaturated monomer:

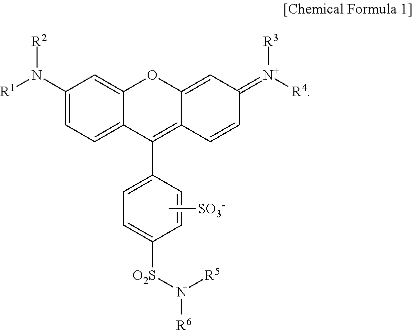

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 3, provided that at least one of R⁵ and R⁶ is represented by the following Chemical Formula 3:

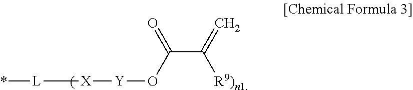

In the above Chemical Formula 3,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene,

R⁹ is hydrogen or substituted or unsubstituted C1 to C20 alkyl, and

n1 is an integer of 1 or 2.

The polymer may be a urea polymer.

The urea polymer may be formed by a copolymerization reaction of a compound represented by the following Chemical Formula 1 and an isocyanate monomer:

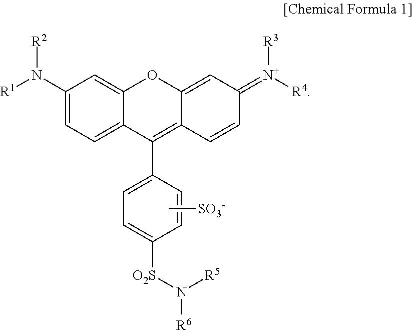

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 4, provided that at least one of R⁵ and R⁶ is represented by the following Chemical Formula 4:

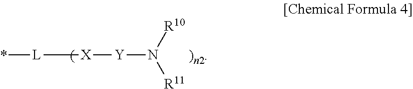

In the above Chemical Formula 4,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene,

R¹⁰ and R¹¹ are the same or different and are each independently hydrogen or substituted or unsubstituted C1 to C20 alkyl, and

n2 is an integer of 1 or 2.

The polymer may be an urethane polymer.

The urethane polymer may be formed by a copolymerization reaction of a compound represented by the following Chemical Formula 1 and an alcohol monomer:

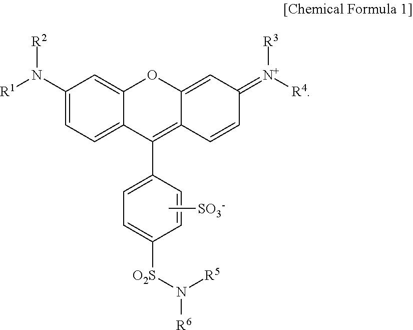

In the above Chemical Formula 1,

R¹ to R⁴ are the same or different and are each independently hydrogen, substituted or unsubstituted C1 to C20 alkyl, substituted or unsubstituted C6 to

C20 aryl, or a combination thereof, and

R⁵ and R⁶ are the same or different and are each independently hydrogen or represented by the following Chemical Formula 5, provided that at least one of R⁵ and R⁶ is represented by the following Chemical Formula 5:

*-LX—Y—NCO)ₙ₃. [Chemical Formula 5]

In the above Chemical Formula 5,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene, and

n3 is an integer of 1 or 2.

The urethane polymer may be formed by a copolymerization reaction of a compound represented by the following Chemical Formula 1 and an isocyanate monomer:

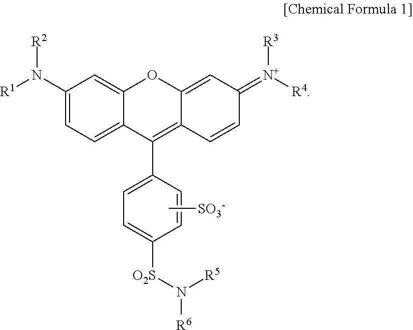

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 6, provided that at least one of R⁵ and R⁶ is represented by the following Chemical Formula 6:

*-LX—Y—OH)ₙ₄. [Chemical Formula 6]

In the above Chemical Formula 6,

L is a divalent or trivalent aliphatic organic group or a divalent or trivalent alicyclic organic group,

X is a single bond, substituted or unsubstituted C1 to C20 alkylene or substituted or unsubstituted C3 to C20 cycloalkylene,

Y is a single bond, —OR″— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene, and

n4 is an integer of 1 or 2.

Yet another embodiment provides a colorant including the compound or the polymer.

Still another embodiment provides a photosensitive resin composition including the colorant.

The photosensitive resin composition may further include a binder resin, a photopolymerizable monomer, a photopolymerization initiator, and a solvent.

A further embodiment provides a color filter manufactured from the photosensitive resin composition.

The compound and/or the polymer can have excellent heat resistance and solubility, high color transmittance and a high contrast ratio and thus may be used to prepare a colorant and then a photosensitive resin composition including the colorant to manufacture a color filter that can have excellent luminance, solvent-resistance, heat resistance, and the like.

### BRIEF DESCRIPTION OF THE DRAWINGS

FIG. 1 is a graph showing transmittance of a methanol solution including 1 wt % of a compound represented by Chemical Formula 3-1.

FIG. 2 is a graph showing transmittance of a methanol solution including 1 wt % of a compound represented by Chemical Formula 6-3.

FIG. 3 is a graph showing transmittance of a methanol solution including 1 wt % of a compound represented by Chemical Formula 7-1.

FIG. 4 is a graph showing transmittance of a methanol solution including 1 wt % of a compound represented by Chemical Formula 7-2.

FIG. 5 is a graph showing transmittance of a methanol solution including 1 wt % of a compound represented by Chemical Formula 8-1.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” refers to one substituted with a substituent including halogen (F, Br, Cl or I), a hydroxy group, a nitro group, a cyano group, an amine group (NH₂, NH(R²⁰⁰) or N(R²⁰¹)(R²⁰²), wherein R²⁰⁰, R²⁰¹ and R²⁰² are the same or different and are each independently C1 to C10 alkyl), an amidino group, a hydrazine group, a hydrazone group, a carboxyl group, substituted or unsubstituted alkyl, substituted or unsubstituted alkenyl, substituted or unsubstituted alkynyl, a substituted or unsubstituted alicyclic organic group, substituted or unsubstituted aryl, and/or a substituted or unsubstituted heterocyclic group, instead of a functional group of the present invention.

As used herein, when a specific definition is not otherwise provided, the term “alkyl” refers to C1 to C30 alkyl, for example C1 to C15 alkyl, the term “cycloalkyl” refers to C3 to C30 cycloalkyl, for example C3 to C18 cycloalkyl, the term “alkoxy” refers to C1 to C30 alkoxy, for example C1 to C18 alkoxy, the term “aryl” refers to C6 to C30 aryl, for example C6 to C18 aryl, the term “alkenyl” refers to C2 to C30 alkenyl, for example C2 to C18 alkenyl, the term “alkylene” refers to C1 to C30 alkylene, for example C1 to C18 alkylene, and the term “arylene” refers to C6 to C30 arylene, for example C6 to C16 arylene.

As used herein, when a specific definition is not otherwise provided, the term “aliphatic organic group” refers to C1 to C30 alkyl, C2 to C30 alkenyl, C2 to C30 alkynyl, C1 to C30 alkylene, C2 to C30 alkenylene, or C2 to C30 alkynylene, for example C1 to C15 alkyl, C2 to C15 alkenyl, C2 to C15 alkynyl, C1 to C15 alkylene, C2 to C15 alkenylene, or C2 to C15 alkynylene, the term “alicyclic organic group” refers to C3 to C30 cycloalkyl, C3 to C30 cycloalkenyl, C3 to C30 cycloalkynyl, C3 to C30 cycloalkylene, C3 to C30 cycloalkenylene, or C3 to C30 cycloalkynylene, for example C3 to C15 cycloalkyl, C3 to C15 cycloalkenyl, C3 to C15 cycloalkynyl, C3 to C15 cycloalkylene, C3 to C15 cycloalkenylene, or C3 to C15 cycloalkynylene, the term “aromatic organic group” refers to C6 to C30 aryl or C6 to C30 arylene, for example C6 to C16 aryl or C6 to C16 arylene, the term “heterocyclic” refers to C2 to C30 cycloalkyl, C2 to C30 cycloalkylene, C2 to C30 cycloalkenyl, C2 to C30 cycloalkenylene, C2 to C30 cycloalkynyl, C2 to C30 cycloalkynylene, C2 to C30 heteroaryl, or C2 to C30 heteroarylene that include 1 to 3 heteroatoms including O, S, N, P, Si, or a combination thereof in a ring, for example C2 to C15 cycloalkyl, C2 to C15 cycloalkylene, C2 to C15 cycloalkenyl, C2 to C15 cycloalkenylene, C2 to C15 cycloalkynyl, C2 to C15 cycloalkynylene, C2 to C15 heteroaryl, or C2 to C15 heteroarylene that include 1 to 3 heteroatoms including O, S, N, P, Si, or a combination thereof in a ring.

The term “cycloalkenylene” in the present specification includes “bicycloalkenylene”.

As used herein, when a definition is not otherwise provided, the term “combination” refers to mixing and/or copolymerization. In addition, “copolymerization” refers to block copolymerization and/or random copolymerization, and “copolymer” refers to a block copolymer and/or a random copolymer.

In the chemical formula of the present specification, unless a specific definition is otherwise provided, hydrogen is bonded at a position where a chemical bond would otherwise appear.

As used herein, when a specific definition is not otherwise provided, “*” indicates a point where the same or different atom or chemical formula is linked.

A compound according to one embodiment is represented by the following Chemical Formula:

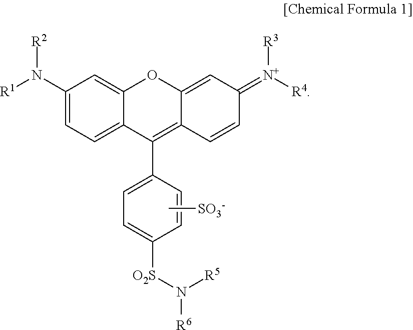

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 2:

*-LX—Y—Z)ₙ. [Chemical Formula 2]

In the above Chemical Formula 2,

L is a single bond, a divalent or trivalent aliphatic organic group, or a divalent or trivalent alicyclic organic group,

X is a single bond, substituted or unsubstituted C1 to C20 alkylene, substituted or unsubstituted C3 to C20 cycloalkylene, or substituted or unsubstituted C6 to C20 arylene,

Y is a single bond, —O—, —C(═O)—, —C(═O)R′—, —OR″—, —R″O— or —OC(═O)NHR′″—, wherein R′ to R′″ are the same or different and are each independently substituted or unsubstituted C1 to C20 alkylene, substituted or unsubstituted C3 to C20 cycloalkylene, or substituted or unsubstituted C6 to C20 arylene,

Z is a substituted or unsubstituted acrylate group, a substituted or unsubstituted amine group, an isocyanate group, a hydroxy group, substituted or unsubstituted C1 to C20 alkyl or —OC(═O)R″″, wherein R″″ is substituted or unsubstituted C1 to C20 alkyl, and

n is an integer of 1 or 2.

For example, the L may be a single bond,

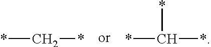

The R⁵ and R⁶ may both be represented by the above Chemical Formula 2. Herein, the compound may have excellent compatibility with an organic material and thus excellent solubility in an organic solvent compared with a compound in which only one of the R⁵ and R⁶ is represented by Chemical Formula 2 and in which the R⁵ and R⁶ are all hydrogen atoms.

The above Chemical Formula 2 may be represented by one or more of the following Chemical Formula 3 to Chemical Formula 6:

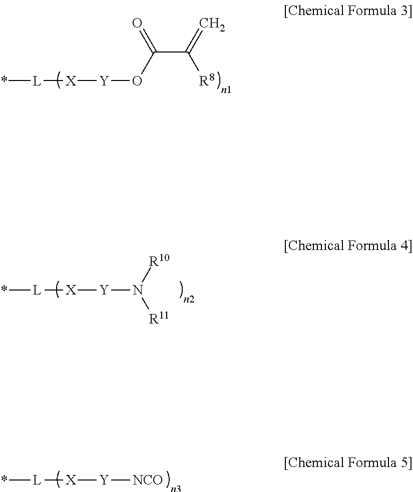

*-LX—Y—OH)ₙ₄. [Chemical Formula 6]

In the above Chemical Formula 3 to Chemical Formula 6,

L is a single bond, a divalent or trivalent aliphatic organic group, or a divalent or trivalent alicyclic organic group,

X is a single bond, substituted or unsubstituted C1 to C20 alkylene, substituted or unsubstituted C3 to C20 cycloalkylene, or substituted or unsubstituted C6 to C20 arylene,

Y is a single bond, —OR″— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene,

R⁹ to R¹¹ are the same or different and are each independently hydrogen or substituted or unsubstituted C1 to C20 alkyl, and

n1 to n4 are the same or different and are each independently integers of 1 or 2.

The compound including a functional group represented by one of the above Chemical Formulae 3 to 6 can have high transmittance and excellent coloring properties and thus may be usefully used as a colorant.

The compound including the functional group represented by the above Chemical Formula 3 may include, for example, one of compounds represented by the following Chemical Formulae 3-1 to 3-11, but is not limited thereto:

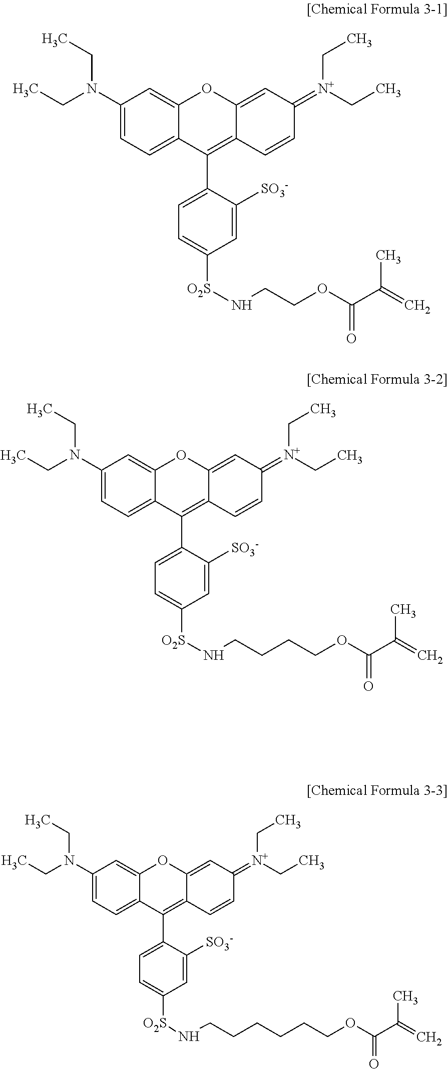

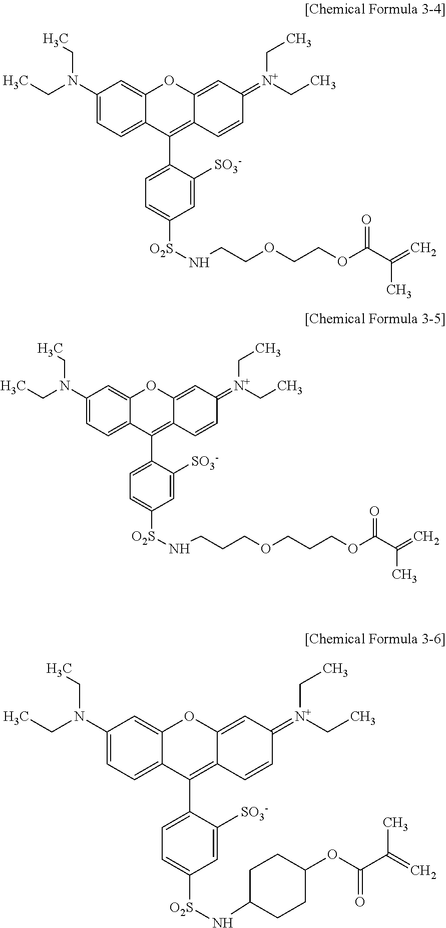

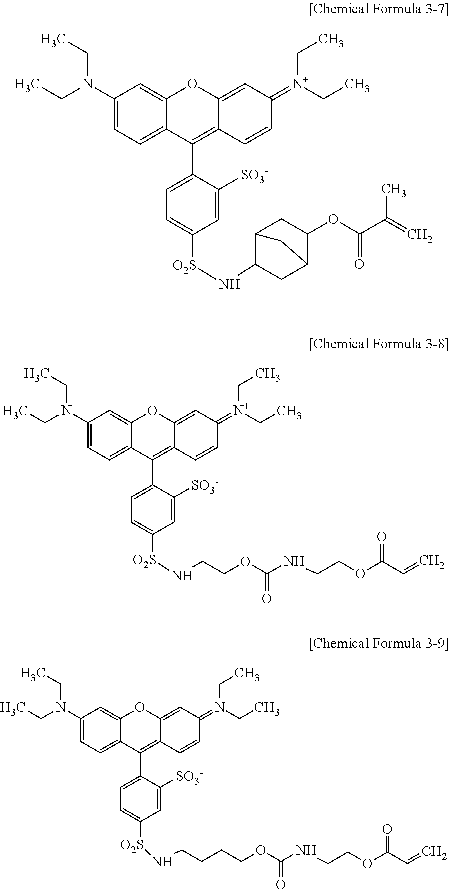

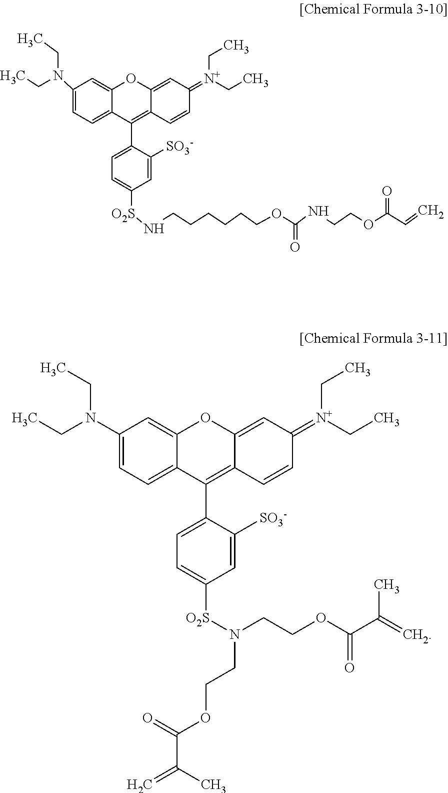

The compound including the functional group represented by the above Chemical Formula 4 may include, for example one of compounds represented by the following Chemical Formulae 4-1 to 4-3, but is not limited thereto:

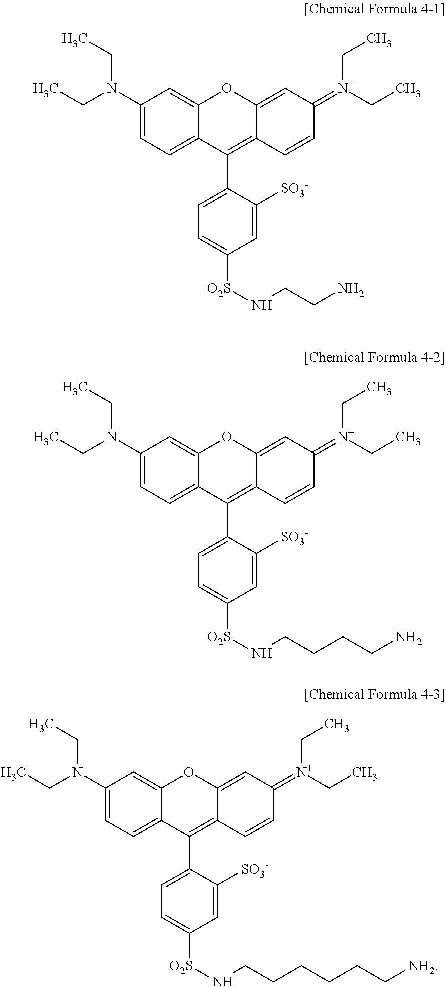

The compound including the functional group represented by the above Chemical Formula 5 may include, for example one of compounds represented by the following Chemical Formulae 5-1 to 5-3, but is not limited thereto:

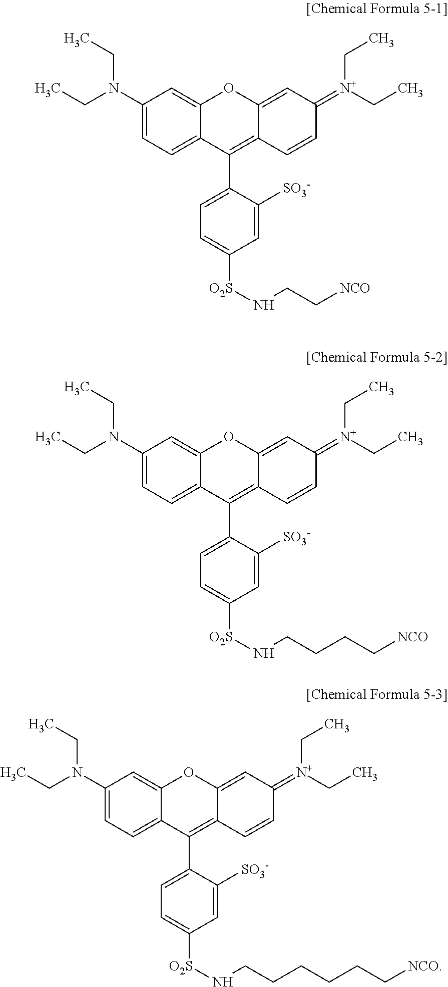

The compound including the functional group represented by the above Chemical Formula 6 may include, for example one of compounds represented by the following Chemical Formulae 6-1 to 6-6, but is not limited thereto:

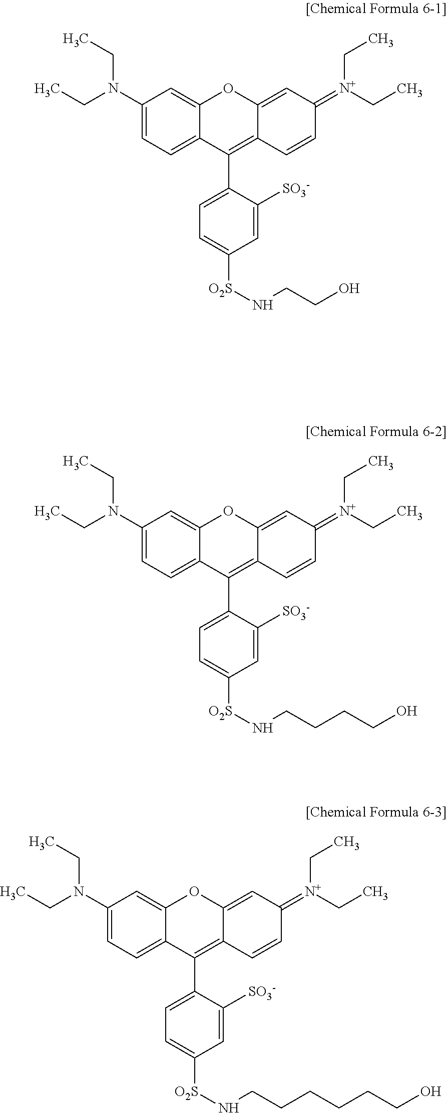

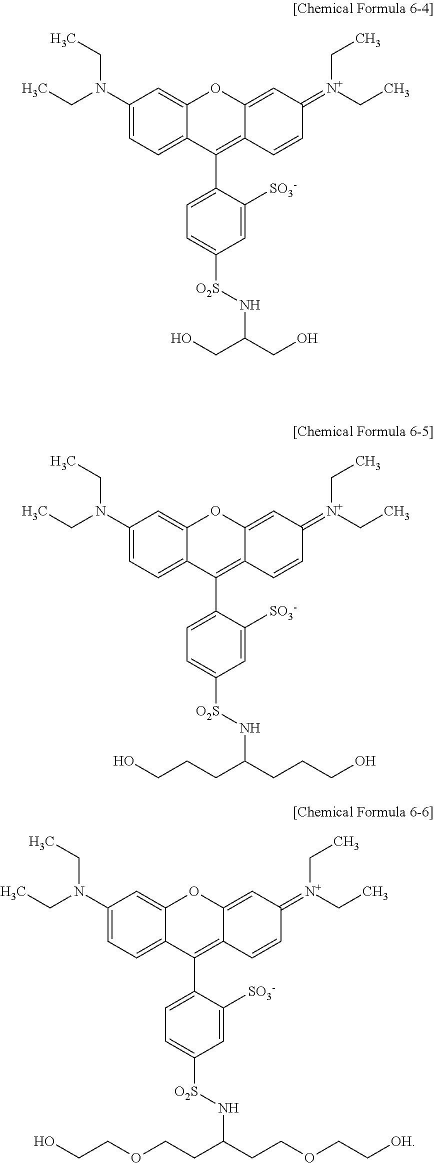

The above Chemical Formula 2 may be represented by one of the following Chemical Formula 7 to Chemical Formula 10:

*-L(CH₂)ₘ₁—CH₃)ₙ₅ [Chemical Formula 7]

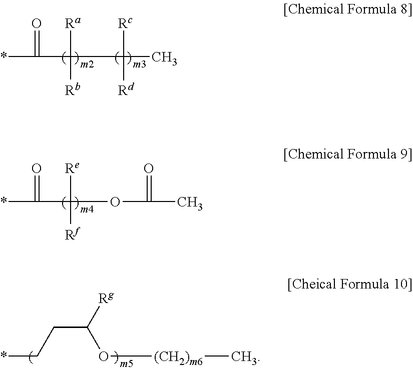

In the above Chemical Formula 7 to Chemical Formula 10,

L is a single bond, a divalent or trivalent aliphatic organic group, or a divalent or trivalent alicyclic organic group,

R^{a} to R^{g} are the same or different and are each independently hydrogen or substituted or unsubstituted C1 to C20 alkyl,

n5 is an integer of 1 or 2,

m1 to m4, and m6 are the same or different and are each independently integers ranging from 0 to 15, and

m5 is an integer ranging from 1 to 5.

In the above Chemical Formula 1, when at least one of the R⁵ and R⁶ is represented by one of the above Chemical Formulae 7 to 10, solubility and spectral characteristics may be excellent.

The functional group represented by the above Chemical Formula 8 may be represented by one of the following Chemical Formula A to Chemical Formula L, but is not limited thereto:

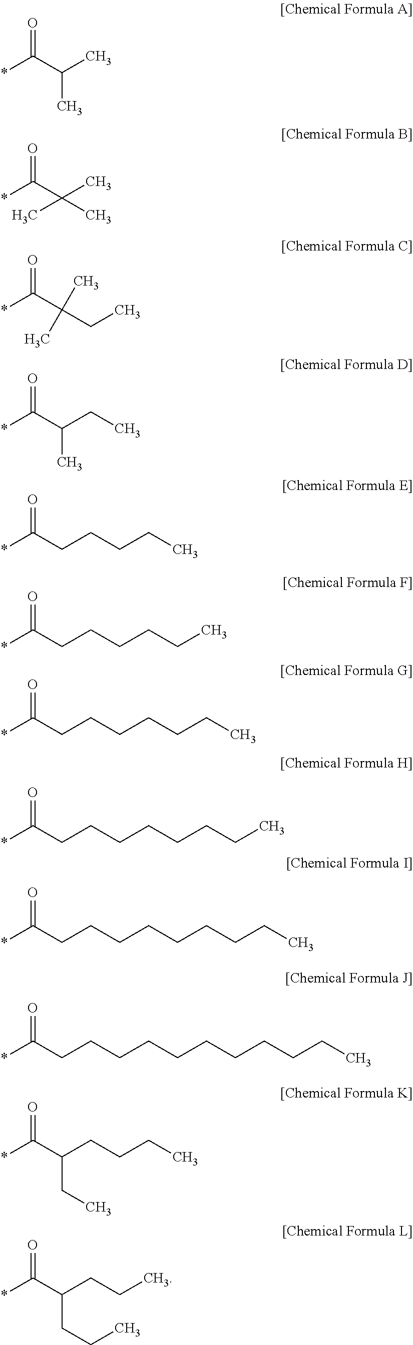

The functional group represented by the above Chemical Formula 9 may be represented by the following Chemical Formula M or Chemical Formula N, but is not limited thereto:

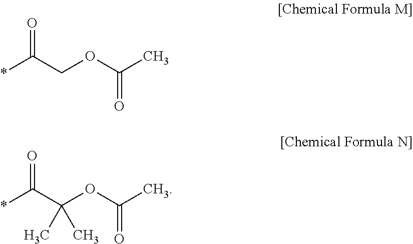

The compound including the functional group represented by the above Chemical Formula 7 may be, for example a compound represented by the following Chemical Formula 7-1 or 7-2, but is not limited thereto:

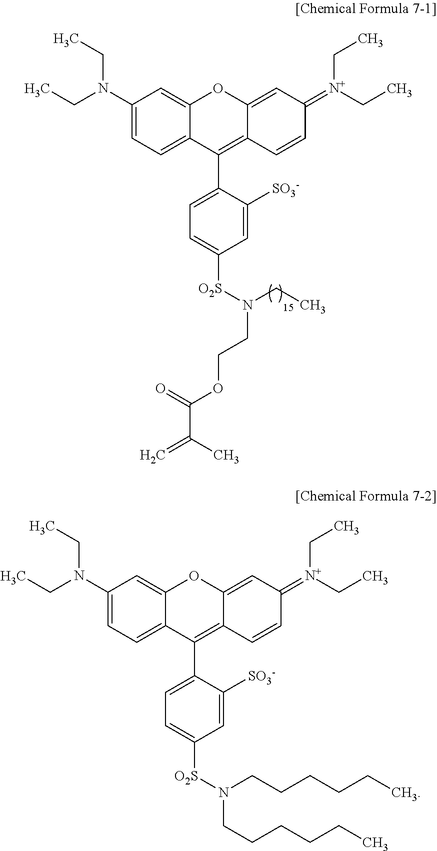

The compound including the functional group represented by the above Chemical Formula 8 may be, for example a compound represented by the following Chemical Formula 8-1, but is not limited thereto:

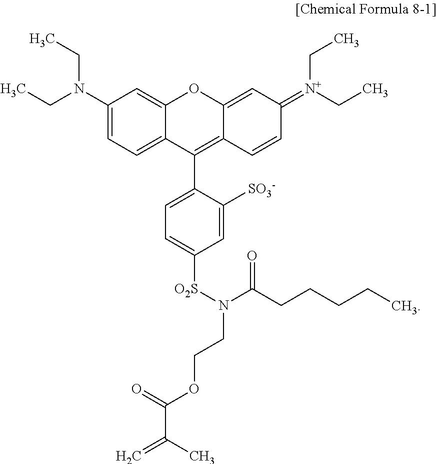

Another embodiment provides a polymer formed by a copolymerization reaction of the compound and a monomer.

Examples of the monomer may include without limitation ethylenic unsaturated monomers, isocyanate monomers, alcohol monomers, and the like, and combinations thereof.

Examples of the ethylenic unsaturated monomer may include without limitation aromatic vinyl compounds, unsaturated carboxylate ester compounds, unsaturated amino alkyl carboxylate ester compounds, vinyl carboxylate ester compounds, unsaturated carboxylic acid glycidyl ester compounds, vinyl cyanide compounds, unsaturated amide compounds, and the like, and combinations thereof.

Examples of the ethylenic unsaturated monomer may include without limitation aromatic vinyl compounds such as styrene, α-methylstyrene, vinyltoluene, vinylbenzylmethylether, and the like; unsaturated carboxylate ester compounds such as methyl(meth)acrylate, ethyl(meth)acrylate, butyl(meth)acrylate, 2-hydroxyethyl(meth)acrylate, 2-hydroxy butyl(meth)acrylate, benzyl(meth)acrylate, cyclohexyl(meth)acrylate, phenyl(meth)acrylate, and the like; unsaturated amino alkyl carboxylate ester compounds such as 2-aminoethyl(meth)acrylate, 2-dimethylaminoethyl(meth)acrylate and the like; vinyl carboxylate ester compounds such as vinyl acetate, vinyl benzoate, and the like; unsaturated carboxylic acid glycidyl ester compounds such as glycidyl(meth)acrylate, and the like; vinyl cyanide compounds such as (meth)acrylonitrile, and the like; unsaturated amide compounds such as (meth)acrylamide and the like; and the like and combinations thereof.

The isocyanate monomer may be a monomer including an isocyanate group, including generally well-known aliphatic and/or aromatic diisocyanate compounds. Examples of the isocyanate monomer may include without limitation 2,2′-diphenylmethane diisocyanate (MDI), 2,4′-diphenylmethane diisocyanate (MDI), 4,4′-diphenylmethane diisocyanate (MDI), a polymeric MDI, 1,5-naphthylene diisocyanate (NDI), 2,4-2,6-tolylene diisocyanate (TDI), 2,6-tolylene diisocyanate (TDI), 3,3′-dimethylbiphenyl diisocyanate, 1,2-diphenylethane diisocyanate, phenyl diisocyanate, trimethylene diisocyanate, tetramethylene diisocyanate, pentamethylene diisocyanate, hexamethylene diisocyanate, heptamethylene diisocyanate, octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane (HXDI), 1,3-bis(isocyanatomethyl)cyclohexane (HXDI), 1,4-cyclohexane diisocyanate, 1-methyl-2,4-cyclohexane diisocyanate, 1-methyl-2,6-cyclohexane diisocyanate, 4,4′-dicyclohexylmethane diisocyanate (H12MDI), 2,4′-dicyclohexylmethane diisocyanate (H12MDI), 2,2′-dicyclohexylmethane diisocyanate (H12MDI), and the like, and combinations thereof.

The term alcohol monomer indicates a monomer including an alcohol group. Examples of the alcohol monomer may include without limitation polyesterols, polyether amines and/or polycarbonate diol compounds, for example, polyalkylene glycols, and as another example, copolymers and the like obtained through an addition reaction of polytetrahydrofuran (PTHF), polybutylene glycol, polypropylene glycol, polyethylene glycol and ethylene oxide, butylene oxide and/or propylene oxide.

The polymer may be an acrylic polymer, an urea polymer and/or an urethane polymer.

The acrylic polymer may be formed by a copolymerization reaction of a compound represented by Chemical Formula 1 including a functional group represented by Chemical Formula 3 and the ethylenic unsaturated monomer.

For example, the compound represented by Chemical Formula 1 including the functional group represented by Chemical Formula 3 is as follows:

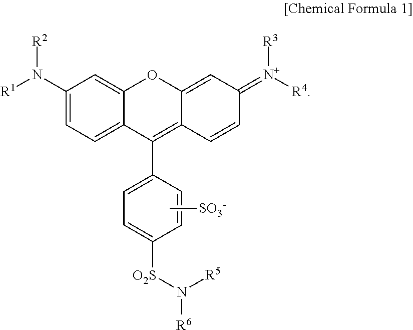

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 3, provided that at least one of R⁵ and R⁶ is represented by the following Chemical Formula 3:

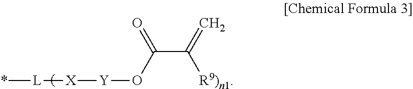

In the above Chemical Formula 3,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″—, —R″O— or —OC(═O)NHR′″—, wherein R″ and R′″ are the same or different and are each independently substituted or unsubstituted C1 to C20 alkylene or substituted or unsubstituted C3 to C20 cycloalkylene,

R⁹ is hydrogen or substituted or unsubstituted C1 to C20 alkyl, and

n1 is an integer of 1 or 2.

The urea polymer may be formed by a copolymerization reaction of a compound represented by Chemical Formula 1 including a functional group represented by Chemical Formula 4 and the isocyanate monomer.

For example, the compound represented by Chemical Formula 1 including the functional group represented by Chemical Formula 4 is as follows:

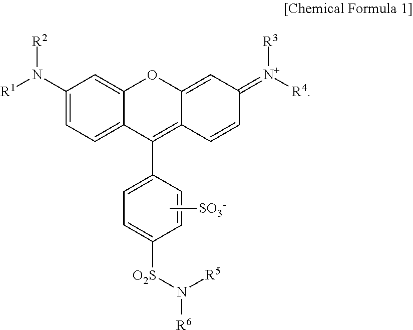

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 4, provided that at least one of R⁵ and R⁶ is represented by the following Chemical Formula 4:

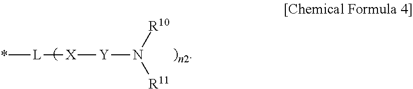

In the above Chemical Formula 4,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″—, —R″O— or —OC(═O)NHR′″—, wherein R″ and R′″ are the same or different and are each independently substituted or unsubstituted C1 to C20 alkylene or substituted or unsubstituted C3 to C20 cycloalkylene,

R¹⁰ and R¹¹ are the same or different and are each independently hydrogen or substituted or unsubstituted C1 to C20 alkyl, and

n2 is an integer of 1 or 2.

The urethane polymer may be formed by a copolymerization reaction of the compound represented by Chemical Formula 1 including a functional group represented by Chemical Formula 5 and the alcohol monomer.

For example, the compound represented by Chemical Formula 1 including the functional group represented by Chemical Formula 5 is as follows:

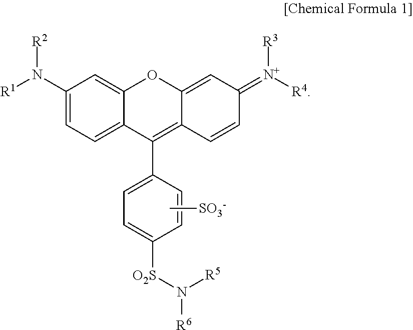

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 5, provided that at least one of R⁵ and R⁶ is represented by the following Chemical Formula 5:

*-LX—Y—NCO)ₙ₃. [Chemical Formula 5]

In the above Chemical Formula 5,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″—, —R″O— or —OC(═O)NHR′″—, wherein R″ and R′″ are the same or different and are each independently substituted or unsubstituted C1 to C20 alkylene or substituted or unsubstituted C3 to C20 cycloalkylene, and n3 is an integer of 1 or 2.

The urethane polymer may be formed by a copolymerization reaction of a compound represented by Chemical Formula 1 including a functional group represented by Chemical Formula 6 and the isocyanate monomer.

For example, the compound represented by Chemical Formula 1 including the functional group represented by Chemical Formula 6 is as follows:

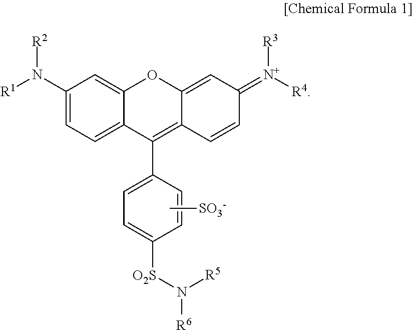

In the above Chemical Formula 1,

R¹ to R⁴ are the same or different and are each independently hydrogen, substituted or unsubstituted C1 to C20 alkyl, substituted or unsubstituted C6 to C20 aryl, or a combination thereof, and

R⁵ and R⁶ are the same or different and are each independently hydrogen or represented by the following Chemical Formula 6, provided that at least one of R⁵ and R⁶ is represented by the following Chemical Formula 6:

*-LX—Y—OH)ₙ₄. [Chemical Formula 6]

In the above Chemical Formula 6,

L is a single bond, a divalent or trivalent aliphatic organic group, or a divalent or trivalent alicyclic organic group,

X is a single bond, substituted or unsubstituted C1 to C20 alkylene or substituted or unsubstituted C3 to C20 cycloalkylene,

Y is a single bond, —OR″—, —R″O— or —OC(═O)NHR′″—, wherein R″ and R′″ are the same or different and are each independently substituted or unsubstituted C1 to C20 alkylene or substituted or unsubstituted C3 to C20 cycloalkylene, and

n4 is an integer of 1 or 2.

The compound and/or the polymer may be used as a dye.

Another embodiment provides a colorant including the compound and/or the polymer.

Another embodiment provides a photosensitive resin composition including the colorant.

The photosensitive resin composition may further include a binder resin, a photopolymerizable monomer, a photopolymerization initiator, and a solvent.

Hereinafter, the components are described.

Colorant

The colorant may further include an organic solvent-soluble dye in addition to the compound and/or the polymer described above.

Examples of the organic solvent-soluble dye may include without limitation triarylmethane-based compounds, anthraquinone-based compounds, benzylidene-based compounds, cyanine-based compounds, phthalocyanine-based compounds, azaporphyrin-based compounds, indigo-based compounds, and the like, and combinations thereof.

The colorant may further include a pigment in addition to the compound and/or the polymer.

Examples of the pigment may include without limitation blue pigments, violet pigments, red pigments, green pigments, yellow pigments, and the like, and combinations thereof.

Examples of the blue pigment may include without limitation C.I. blue pigment 15:6, C.I. blue pigment 15, C.I. blue pigment 15:1, C.I. blue pigment 15:2, C.I. blue pigment 15:3, C.I. blue pigment 15:4, C.I. blue pigment 15:5, C.I. blue pigment 16, C.I. blue pigment 22, C.I. blue pigment 60, C.I. blue pigment 64, C.I. blue pigment 80, and the like, and combinations thereof.

Examples of the violet pigment may include without limitation C.I violet pigment 1, C.I violet pigment 19, C.I violet pigment 23, C.I violet pigment 27, C.I violet pigment 29, C.I violet pigment 30, C.I violet pigment 32, C.I violet pigment 37, C.I violet pigment 40, C.I violet pigment 42, C.I violet pigment 50, and the like, and combinations thereof.

Examples of the red pigment may include without limitation perylene-based pigments, anthraquinone-based pigments, dianthraquinone-based pigments, azo-based pigments, diazo-based pigments, quinacridone-based pigments, anthracene-based pigments, and the like, and combinations thereof. Examples of the red pigment may include without limitation perylene pigments, quinacridone pigments, naphthol AS, sicomin pigments, anthraquinones (sudan I, II, III, R), bis azos, benzopyrane, and the like, and combinations thereof.

Examples of the green pigment may include without limitation halogenated phthalocyanine-based pigments, for example polychloro copper phthalocyanines, polychloro bromo phthalocyanines, and the like, and combinations thereof.

Examples of the yellow pigment may include without limitation tetra chloro isoindolinone-based pigments, hansa-based pigments, benzidine yellow-based pigments, azo-based pigments, and the like, and the like, and combinations thereof. Examples of the yellow-based pigment may include without limitation hansa yellow (10G, 5G, 3G, G, GR, A, RN, R), benzidine (G, GR), chrome yellow, permanent yellow (FGL, H10G, HR), anthracene, and the like, and combinations thereof.

Binder Resin

The binder resin may be an acrylic-based binder resin.

The acrylic-based binder resin is a copolymer of a first ethylenic unsaturated monomer and a second ethylenic unsaturated monomer that is copolymerizable with the first ethylenic unsaturated monomer and also includes at least one acrylic-based repeating unit.

The first ethylenic unsaturated monomer is an ethylenic unsaturated monomer including at least one carboxyl group. Examples of the first ethylenic unsaturated monomer include without limitation acrylic acid, methacrylic acid, maleic acid, itaconic acid, fumaric acid, and the like, and combinations thereof.

The first ethylenic unsaturated monomer may be included in an amount ranging from about 5 to about 50 wt %, for example from about 10 to about 40 wt %, based on the total amount (total weight, 100 wt %) of the acrylic-based binder resin.

Examples of the second ethylenic unsaturated monomer may include without limitation aromatic vinyl compounds such as styrene, α-methylstyrene, vinyltoluene, vinylbenzylmethylether, and the like; unsaturated carboxylate ester compounds such as methyl(meth)acrylate, ethyl(meth)acrylate, butyl(meth)acrylate, 2-hydroxyethyl(meth)acrylate, 2-hydroxy butyl(meth)acrylate, benzyl(meth)acrylate, cyclohexyl(meth)acrylate, phenyl(meth)acrylate, and the like; unsaturated amino alkyl carboxylate ester compounds such as 2-aminoethyl(meth)acrylate, 2-dimethylaminoethyl(meth)acrylate and the like; vinyl carboxylate ester compounds such as vinyl acetate, vinyl benzoate, and the like; unsaturated carboxylic acid glycidyl ester compounds such as glycidyl(meth)acrylate and the like; vinyl cyanide compounds such as (meth)acrylonitrile, and the like; unsaturated amide compounds such as (meth)acrylamide and the like; and the like. These may be used singularly or as a mixture of two or more.

Examples of the acryl-based binder resin may include without limitation a (meth)acrylic acid/benzylmethacrylate copolymer, a (meth)acrylic acid/benzylmethacrylate/styrene copolymer, a (meth)acrylic acid/benzylmethacrylate/2-hydroxyethyl methacrylate copolymer, a (meth)acrylic acid/benzylmethacrylate/styrene/2-hydroxyethyl methacrylate copolymer, and the like. However, they are not limited thereto, and may be used singularly or as a mixture of two or more.

The acrylic-based binder resin may have a weight average molecular weight ranging from about 3,000 to about 150,000 g/mol, for example, about 5,000 to about 50,000 g/mol, and as another example, about 2,000 to about 30,000 g/mol. When the acrylic-based binder resin has a weight average molecular weight within the above range, the photosensitive resin composition can have good physical and chemical properties and can have an appropriate viscosity.

The acrylic-based binder resin may have an acid value of about 15 to about 60 mgKOH/g, for example, about 20 to about 50 mgKOH/g. When the acrylic-based binder resin has an acid value within the above range, excellent pixel resolution may be realized.

The photosensitive resin composition may include the acrylic-based binder resin in an amount of about 1 to about 30 wt %, for example about 1 to about 20 wt %, based on the total amount (total weight, 100 wt %) of the photosensitive resin composition. In some embodiments, the photosensitive resin composition may include the acrylic-based binder resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the acrylic-based binder resin can be in a range from about any of the foregoing amounts to about any other of the foregoing amounts.

When the acrylic-based binder resin is included in an amount within the above range, developability may be improved and excellent surface smoothness may be improved due to improved cross-linking during the manufacture of a color filter.

Photopolymerizable Monomer

The photopolymerizable monomer may be a mono-functional and/or multi-functional ester of (meth)acrylic acid including at least one ethylenic unsaturated double bond.

The photopolymerizable monomer has the ethylenic unsaturated double bond and thus, may cause sufficient polymerization during exposure in a pattern-forming process and form a pattern having excellent heat resistance, light resistance, and chemical resistance.

Examples of the photopolymerizable monomer may include without limitation ethylene glycol di(meth)acrylate, diethylene glycol di(meth)acrylate, triethylene glycol di(meth)acrylate, propylene glycol di(meth)acrylate, neopentyl glycol di(meth)acrylate, 1,4-butanediol di(meth)acrylate, 1,6-hexanediol di(meth)acrylate, bisphenolA di(meth)acrylate, pentaerythritol di(meth)acrylate, pentaerythritol tri(meth)acrylate, pentaerythritol tetra(meth)acrylate, pentaerythritol hexa(meth)acrylate, dipentaerythritol di(meth)acrylate, dipentaerythritol tri(meth)acrylate, dipentaerythritol penta(meth)acrylate, dipentaerythritol hexa(meth)acrylate, bisphenol A epoxy(meth)acrylate, ethylene glycol monomethylether(meth)acrylate, trimethylol propane tri(meth)acrylate, tris(meth)acryloyloxyethyl phosphate, novolacepoxy(meth)acrylate, and the like, and combinations thereof.

Commercially available examples of the reactive unsaturated compound include the following without limitation. Examples of the mono-functional (meth)acrylic acid ester may include without limitation Aronix M-101®, M-111®, and/or M-114® (Toagosei Chemistry Industry Co., Ltd.); KAYARAD TC-110S® and/or TC-120S® (Nippon Kayaku Co., Ltd.); V-158® and/or V-2311® (Osaka Organic Chemical Ind., Ltd.), and the like. Examples of a difunctional (meth)acrylic acid ester may include without limitation Aronix M-210®, M-240®, and/or M-6200® (Toagosei Chemistry Industry Co., Ltd.), KAYARAD HDDA®, HX-220®, and/or R-604® (Nippon Kayaku Co., Ltd.), V-260®, V-312®, and/or V-335 HP® (Osaka Organic Chemical Ind., Ltd.), and the like. Examples of a tri-functional (meth)acrylic acid ester may include without limitation Aronix M-309®, M-400®, M-405®, M-450®, M-7100®, M-8030®, and/or M-8060® (Toagosei Chemistry Industry Co., Ltd.), KAYARAD TMPTA®, DPCA-20®, DPCA-30®, DPCA-60®, and/or DPCA-120® (Nippon Kayaku Co., Ltd.), V-295®, V-300®, V-360®, V-GPT®, V-3PA®, and/or V-400® (Osaka Yuki Kayaku Kogyo Co. Ltd.), and the like. These may be used singularly or as a mixture of two or more.

The photopolymerizable monomer may be treated with acid anhydride to improve developability.

The photosensitive resin composition may include the photopolymerizable monomer in an amount of about 1 wt % to about 20 wt % based on the total amount (total weight, 100 wt %) of the photosensitive resin composition. In some embodiments, the photosensitive resin composition may include the photopolymerizable monomer in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of the photopolymerizable monomer can be in a range from about any of the foregoing amounts to about any other of the foregoing amounts.

When the photopolymerizable monomer is included in an amount within the above range, the photopolymerizable monomer can be sufficiently cured during exposure in a pattern-forming process and can have excellent reliability, and developability for alkali developing solution may be improved.

Photopolymerization Initiator

Examples of the photopolymerization initiator may include without limitation acetophenone-based compounds, benzophenone-based compounds, thioxanthone-based compounds, benzoin-based compounds, triazine-based compounds, oxime-based compounds, and the like, and combinations thereof.

Examples of the acetophenone-based compound may include without limitation 2,2′-diethoxy acetophenone, 2,2′-dibutoxy acetophenone, 2-hydroxy-2-methylpropiophenone, p-t-butyltrichloro acetophenone, p-t-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like, and combinations thereof.

Examples of the benzophenone-based compound may include without limitation benzophenone, benzoyl benzoate, benzoyl benzoate methyl, 4-phenyl benzophenone, hydroxy benzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like, and combinations thereof.

Examples of the thioxanthone-based compound may include without limitation thioxanthone, 2-methylthioxanthone, isopropyl thioxanthone, 2,4-diethyl thioxanthone, 2,4-diisopropyl thioxanthone, 2-chlorothioxanthone, and the like, and combinations thereof.

Examples of the benzoin-based compound may include without limitation benzoin, benzoin methyl ether, benzoin ethyl ether, benzoin isopropyl ether, benzoin isobutyl ether, benzyldimethylketal, and the like, and combinations thereof.

Examples of the triazine-based compound may include without limitation 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloro methyl)-s-triazine, 2-biphenyl-4,6-bis(trichloro methyl)-s-triazine, bis(trichloromethyl)-6-styryl-s-triazine, 2-(naphtho1-yl)-4,6-bis(trichloromethyl)-s-triazine, 2-(4-methoxynaphtho1-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like, and combinations thereof.

Examples of the oxime-based compound may include without limitation 2-(o-benzoyloxime)-1-[4-(phenylthio)phenyl]-1,2-octandione, 1-(o-acetyloxime)-1-[9-ethyl-6-(2-methylbenzoyl)-9H-carbazol-3-yl]ethanone, and the like, and combinations thereof.

The photopolymerization initiator may further include one or more of a carbazole-based compound, a diketone-based compound, a sulfonium borate-based compound, a diazo-based compound, an imidazole-based compound, a biimidazole-based compound, and the like instead of or in addition to the compounds.

The photosensitive resin composition may include the photopolymerization initiator in an amount of about 0.1 wt % to about 10 wt % based on the total amount (total weight, 100 wt %) of the photosensitive resin composition. In some embodiments, the photosensitive resin composition may include the photopolymerization initiator in an amount of about 0.1, 0.2, 0.3, 0.4, 0.5, 0.6, 0.7, 0.8, 0.9, 1, 2, 3, 4, 5, 6, 7, 8, 9, or 10 wt %. Further, according to some embodiments of the present invention, the amount of the photopolymerization initiator can be in a range from about any of the foregoing amounts to about any other of the foregoing amounts.

When the photopolymerization initiator is included in an amount within the above range, sufficient photopolymerization can occur during exposure in a pattern-forming process, and transmittance may be prevented from deterioration due to a non-reaction initiator.

Solvent

The solvent is a material having compatibility with the colorant, the acrylic-based binder resin, the photopolymerizable monomer, and the photopolymerization initiator but not reacting therewith.

Examples of the solvent may include without limitation alcohols such as methanol, ethanol and the like; ethers such as dichloroethyl ether, n-butyl ether, diisoamyl ether, methylphenyl ether, tetrahydrofuran, and the like; glycol ethers such ethylene glycol methylether, ethylene glycol ethylether, propylene glycol methylether and the like; cellosolve acetates such as methyl cellosolve acetate, ethyl cellosolve acetate, diethyl cellosolve acetate, and the like; carbitols such methylethyl carbitol, diethyl carbitol, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol methylether acetate, propylene glycol propylether acetate, and the like; aromatic hydrocarbons such as toluene, xylene, and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; alkyl lactate esters such as methyl lactate, ethyl lactate, and the like; hydroxyacetic acid alkyl esters such as methyl hydroxyacetate, ethyl hydroxyacetate, butyl hydroxyacetate, and the like; alkoxyalkyl acetate esters such as methoxymethyl acetate, methoxyethyl acetate, methoxybutyl acetate, ethoxymethyl acetate, ethoxyethyl acetate, and the like; 3-hydroxypropionic acid alkyl esters such as methyl 3-hydroxypropionate, ethyl 3-hydroxypropionate, and the like; 3-alkoxypropionic acid alkyl esters such as methyl 3-methoxypropionate, ethyl 3-methoxypropionate, ethyl 3-ethoxypropionate, methyl 3-ethoxypropionate, and the like; 2-hydroxypropionic acid alkyl esters such as methyl 2-hydroxypropionate, ethyl 2-hydroxypropionate, propyl 2-hydroxypropionate, and the like; 2-alkoxypropionic acid alkyl esters such as methyl 2-methoxypropionate, ethyl 2-methoxypropionate, ethyl 2-ethoxypropionate, methyl 2-ethoxypropionate, and the like; 2-hydroxy-2-methylpropionic acid alkyl esters such as methyl 2-hydroxy-2-methylpropionate, ethyl 2-hydroxy-2-methylpropionate, and the like; 2-alkoxy-2-methylpropionic acid alkyl esters such as methyl 2-methoxy-2-methyl propionate, ethyl 2-ethoxy-2-methylpropionate, and the like; esters such as 2-hydroxyethyl propionate, 2-hydroxy-2-methylethyl propionate, hydroxyethyl acetate, methyl 2-hydroxy-3-methylbutanoate, and the like; ketonate esters such as ethyl pyruvate, and the like, and combinations thereof. Additionally, a solvent such as N-methylformamide, N,N-dimethylformamide, N-methylformanilide, N-methylacetamide, N,N-dimethylacetamide, N-methylpyrrolidone, dimethylsulfoxide, benzylethylether, dihexylether, acetylacetone, isophorone, caproic acid, caprylic acid, 1-octanol, 1-nonanol, benzylalcohol, benzyl acetate, ethyl benzoate, diethyl oxalate, diethyl maleate, γ-butyrolactone, ethylene carbonate, propylene carbonate, phenyl cellosolve acetate, and the like, and combinations thereof may be also used. The solvents may be used singularly or as a mixture of two or more.

Considering miscibility and reactivity, glycol ethers such as ethylene glycol monoethyl ether, and the like; ethylene glycol alkylether acetates such as ethyl cellosolve acetate, and the like; esters such as 2-hydroxyethyl propionate, and the like; diethylene glycols such as diethylene glycol monomethyl ether, and the like; and/or propylene glycol alkylether acetates such as propylene glycol monomethylether acetate, propylene glycol propylether acetate, and the like may be preferably used.

The solvent is used in a balance amount, for example about 20 wt % to 90 wt % based on the total amount (total weight, 100 wt %) of the photosensitive resin composition. In some embodiments, the photosensitive resin composition may include the solvent in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the solvent can be in a range from about any of the foregoing amounts to about any other of the foregoing amounts.

When the solvent is included in an amount within the above range, the photosensitive resin composition can have improved coating properties and excellent flatness.

Other Additives

The photosensitive resin composition may further include one or more other additives such as but not limited to malonic acid; 3-amino-1,2-propanediol; a silane-based coupling agent including a vinyl group or a (meth)acryloxy group; a leveling agent; a fluorine-based surfactant; and/or a radical polymerization initiator, in order to prevent stains or spots during the coating, to adjust leveling, and/or to prevent pattern residue due to non-development.

The photosensitive resin composition according to another embodiment may further include an epoxy compound in order to improve close-contacting (adhesive) properties with a substrate.

Examples of the epoxy compound may include without limitation phenol novolac epoxy compounds, tetramethyl biphenyl epoxy compounds, bisphenol A epoxy compounds, alicyclic epoxy compounds, and the like, and combinations thereof.

The amount of the additive(s) may be controlled depending on desired properties.

Another embodiment provides a color filter manufactured using the above photosensitive resin composition. An exemplary method of manufacturing the color filter is as follows.

The photosensitive resin composition for a color filter can be coated to have a thickness of about 3.1 μm to about 3.4 μm using an appropriate method such as a spin coating, a slit coating and the like, on a bare glass substrate or on a glass substrate on which a protective layer SiNx is coated in a thickness of about 500 Å to about 1500 Å. After the coating, the composition can be radiated with a UV ray, an electron beam, or an X-ray to form a pattern required for a color filter. After radiation of the rays, the coating layer can be treated with an alkali developing solution, and the unradiated region thereof may be dissolved, forming a pattern for a color filter. This process can be repeated depending on the necessary number of R, G, and B colors, fabricating a color filter having a desired pattern.

In addition, the image pattern acquired by the development can be cured through heat treatment, actinic ray radiation, or the like, which can improve crack resistance, solvent resistance, and the like.

Hereinafter, the present invention is illustrated in more detail with reference to the following examples. These examples, however, are not in any sense to be interpreted as limiting the scope of the invention.

### (Compound Synthesis)

### Dye Including Acrylate Group

### Synthesis Example 1

### Synthesis Method of Chemical Formula 3-1

735 ml of methylenechloride is put in a flask after putting a stir bar in the flask and cooled down to 0° C. under a nitrogen stream, 85 g (147 mmol) of sulforhodamine B acid chloride is added thereto, and the mixture is agitated. Subsequently, 29.2 g (177 mmol) of 2-aminoethyl methacrylate hydrochloride, 0.899 g (7.37 mmol) of N,N-dimethylamino pyridine, and 38.3 g (53 ml, 295 mmol) of triethyl amine are added thereto, and the resulting mixture is agitated for 15 hours. Then, the mixture is concentrated under a reduced pressure by using a rotary evaporator to obtain a red solid, and the red solid is rinsed with ethylacetate, obtaining 65.9 g of a solid compound (a yield of 67%) represented by the following Chemical Formula 3-1

### [NMR Data]

¹H NMR (300 MHz, CD3OD): δ=8.67 (s, 1H), 8.13 (dd, 1H), 7.52 (d, 1H), 7.17-6.95 (m, 6H), 6.18 (s, 1H), 5.66 (s, 1H), 4.19 (t, 2H), 3.75-3.65 (m, 8H), 3.40-3.36 (m, 2H), 1.96 (s, 3H), 1.34-1.30 (m, 12H)

### Synthesis Example 2

### Synthesis Method of Chemical Formula 3-4

735 ml of methylenechloride is put in a flask after putting a stir bar in the flask and cooled down to 0° C. under a nitrogen stream, 85 g (147 mmol) of sulforhodamine B acid chloride is added thereto, and the mixture is agitated. Subsequently, 18.6 g (177 mmol) of 2-aminoethyl(2-(2-Aminoethoxy) ethanol), 0.899 g (7.37 mmol) of N,N-dimethylamino pyridine, and 38.3 g (53 ml, 295 mmol) of triethyl amine are further added thereto, and the resulting mixture is agitated at room temperature for 15 hours. Subsequently, the mixture is concentrated under a reduced pressure by using a rotary evaporator to obtain a red solid, the red solid is rinsed with ethylacetate and dried, 735 ml of methylenechloride is added thereto, and the mixture is cooled down to 0° C. under a nitrogen stream and then, agitated. 18.5 g (177 mmol) of methacryloyl chloride and 17.9 g (177 mmol) of triethyl amine are added to the mixture, and the resulting mixture is agitated at room temperature for 5 hours. Subsequently, the mixture is concentrated under a reduced pressure by using a rotary evaporator to obtain a red solid, and the red solid is rinsed with ethylacetate, obtaining 72 g of a solid compound represented by the following Chemical Formula 3-4 (a yield of 62%).

### [NMR Data]

¹H NMR (300 MHz, CD3OD): δ=8.67 (s, 1H), 8.17 (dd, 1H), 7.55 (d, 1H), 7.14-6.96 (m, 6H), 6.16 (s, 1H), 5.63 (s, 1H), 4.17 (t, 2H), 4.01 (m, 2H), 3.88 (m, 2H) 3.74-3.63 (m, 8H), 3.37-3.33 (m, 2H), 1.95 (s, 3H), 1.32-1.28 (m, 12H)

### Synthesis Example 3

### Synthesis Method of Chemical Formula 3-6

735 ml of methylenechloride is put in a flask after a stir bar is put in the flask and cooled down to 0° C. under a nitrogen stream, 85 g (147 mmol) of sulforhodamine B acid chloride is added thereto, and the mixture is agitated. Subsequently, 20.4 g (177 mmol) of 2-aminoethyl trans-4-Aminocyclohexanol, 0.899 g (7.37 mmol) of N,N-dimethylamino pyridine, 38.3 g (53 ml, 295 mmol) of triethyl amine are added thereto, and the mixture is agitated at room temperature for 15 hours. Then, the mixture is concentrated under a reduced pressure by using a rotary evaporator to obtain a red solid, the red solid is rinsed with ethylacetate and cleaned, 735 ml of methylenechloride is added thereto, and the mixture is cooled down to 0° C. under a nitrogen stream and agitated. 18.5 g (177 mmol) of methacryloyl chloride and 17.9 g (177 mmol) of triethyl amine are added to the mixture, and the resulting mixture is agitated at room temperature for 5 hours. Subsequently, the mixture is concentrated under a reduced pressure by using a rotary evaporator to obtain a red solid, and the red solid is rinsed with ethylacetate, obtaining 74 g of a solid compound represented by the following Chemical Formula 3-6 (a yield of 63%).

### [NMR Data]

¹H NMR (300 MHz, CD3OD): δ=8.65 (s, 1H), 8.12 (dd, 1H), 7.52 (d, 1H), 7.19-6.97 (m, 6H), 6.16 (s, 1H), 5.64 (s, 1H), 4.17 (s, 1H), 3.75-3.65 (m, 8H), 3.38 (s, 1H), 1.95 (s, 3H), 1.68 (t, 2H), 1.66 (t, 2H), 1.33-1.29 (m, 12H)

### Synthesis Example 4

### Synthesis Method of Chemical Formula 3-8

735 ml of methylenechloride is put in a flask after a stir bar is put in the flask and cooled down to 0° C. under a nitrogen stream, 85 g (147 mmol) of sulforhodamine B acid chloride is agitated, and the mixture is agitated. Subsequently, 10.8 g (177 mmol) of 2-aminoethyl 2-amino ethanol, 0.899 g (7.37 mmol) of N,N-dimethylamino pyridine, and 38.3 g (53 ml, 295 mmol) of triethyl amine are added thereto, and the mixture is agitated at room temperature for 15 hours. Subsequently, the mixture is concentrated under a reduced pressure by using a rotary evaporator to obtain a red solid, the red solid is rinsed with ethylacetate and dried, 735 ml of methylenechloride is added thereto, and the mixture is cooled down to 0° C. under a nitrogen stream and agitated. 27.5 g (177 mmol) of 2-isocyanatoethyl methacrylate and 1.1 g (1.7 mmol) of dibutyltin dilaurate are added thereto, and the resulting mixture is agitated for 5 hours at room temperature. Subsequently, the mixture is concentrated under a reduced pressure by using a rotary evaporator to obtain a red solid, and the red solid is rinsed with ethylacetate, obtaining 80 g of a solid compound represented by the following Chemical Formula 3-8 (a yield of 70%).

### [NMR Data]

¹H NMR (300 MHz, CD3OD): δ=8.68 (s, 1H), 8.14 (dd, 1H), 7.53 (d, 1H), 7.16-6.94 (m, 6H), 6.17 (s, 1H), 5.64 (s, 1H), 4.20 (t, 2H), 4.18 (t, 2H), 3.75-3.65 (m, 8H), 3.40-3.36 (m, 2H), 3.24-3.20 (m, 2H), 1.94 (s, 3H), 1.35-1.31 (m, 12H)

### Synthesis Example 5

### Synthesis Method of Chemical Formula 3-11

735 ml of dimethylformamide is put in a flask after a stir bar is put in the flask and cooled down to 0° C. under a nitrogen stream, 98.5 g (147 mmol) of the red solid represented by the above Chemical Formula 3-1 is added thereto, and the mixture is agitated. Subsequently, 101.6 g (735 mmol) of potassium carbonate and 34.2 g (177 mmol) of 2-bromoethyl methacrylate are further added thereto, and the mixture is agitated at room temperature for 15 hours. Then, the mixture is concentrated under a reduced pressure by using a rotary evaporator to obtain a red solid, and the red solid is rinsed with ethylacetate, obtaining 72.9 g of a solid compound represented by the following Chemical Formula (a yield of 73%).

### [NMR Data]

¹H NMR (300 MHz, CD3OD): δ=8.67 (s, 1H), 8.13 (dd, 1H), 7.52 (d, 1H), 7.17-6.95 (m, 6H), 6.17 (s, 2H), 5.65 (s, 2H), 4.17 (t, 4H), 3.74-3.64 (m, 16H), 3.41-3.37 (m, 4H), 1.97 (s, 6H), 1.34-1.30 (m, 24H)

### Dye Including Amine Group

### Synthesis Example 6

### Synthesis Method of Chemical Formula 4-1

250 ml of methylenechloride is put in a flask after a stir bar is put in the flask and cooled down to 0° C. under a nitrogen stream, 2.5 g (41.6 mmol) of ethylenediamine, 1.4 g (13.9 mmol) of triethyl amine, and 0.25 g (2.05 mmol) of N,N-dimethylamino pyridine are added thereto, and the mixture is agitated. 8 g (13.9 mmol) of sulforhodamine B acid chloride is added to the mixture in a dropwise fashion for 2 hours, and the mixture is agitated at room temperature for 15 hours. Subsequently, the mixture is concentrated under a reduced pressure by using a rotary evaporator to obtain a red solid, and the red solid is rinsed with ethylacetate, obtaining 6.7 g of a solid compound represented by the following Chemical Formula 4-1 (a yield of 81%).

### [NMR Data]

¹H NMR (300 MHz, CD3OD): δ=8.67 (s, 1H), 8.17 (d, 1H), 7.58 (d, 1H), 7.14-6.96 (m, 6H), 6.18 (s, 1H), 5.66 (s, 1H), 4.19 (t, 1H), 3.73-3.66 (m, 8H), 3.51-2.97 (m, 4H), 1.40-1.15 (m, 12H)

### Dye Including Isocyanate Group

### Synthesis Example 7

### Synthesis Method of Chemical Formula 5-1

735 ml of ethylacetate is put in a flask after a stir bar is put in the flask and cooled down to 0° C. under a nitrogen stream, 86.1 g (147 mmol) of the solid represented by the above Chemical Formula 4-1 is added thereto, and the mixture is agitated. Subsequently, 52.5 g (177 mmol) of triphosgene is added thereto, and the obtained mixture is refluxed and agitated for 4 hours. Then, the mixture is concentrated under a reduced pressure by using a rotary evaporator to obtain a red solid, and the red solid is rinsed with ethylacetate, obtaining 70.9 g of a solid compound represented by the following Chemical Formula 5-1 (a yield of 75%).

### [NMR Data]

¹H NMR (300 MHz, CD3OD): δ=8.68 (s, 1H), 8.16 (d, 1H), 7.58 (d, 1H), 7.15-6.94 (m, 6H), 4.18 (t, 1H), 3.73-3.66 (m, 8H), 3.54-2.99 (m, 4H), 1.42-1.17 (m, 12H)

### Dye Including Alcohol Group

### Synthesis Example 8

### Synthesis Method of Chemical Formula 6-1

735 ml of methylenechloride is put in a flask after a stir bar is put in the flask and cooled down to 0° C. under a nitrogen stream, 85 g (147 mmol) of sulforhodamine B acid chloride is added thereto, and the mixture is agitated. Subsequently, 10.8 g (177 mmol) of 2-aminoethyl 2-amino ethanol, 0.899 g (7.37 mmol) of N,N-dimethylamino pyridine, and 38.3 g (53 ml, 295 mmol) of triethyl amine are added thereto, and the obtained mixture is agitated at room temperature for 15 hours. Then, the mixture is concentrated under a reduced pressure by using a rotary evaporator to obtain a red solid, ant the red solid is rinsed with ethylacetate, obtaining 63.5 g of a solid compound represented by the following Chemical Formula 3-1 (a yield of 65%).

### [NMR Data]

¹H NMR (300 MHz, CD3OD): δ=8.67 (s, 1H), 8.16 (d, 1H), 7.58 (d, 1H), 7.13-6.92 (m, 6H), 4.2 (t, 1H), 3.73-3.66 (m, 8H), 3.52-2.97 (m, 4H), 1.42-1.17 (m, 12H)

### Synthesis Example 9

### Synthesis Method of Chemical Formula 6-4

735 ml of methylenechloride is put in a flask after a stir bar is put in the flask and cooled down to 0° C. under a nitrogen stream, 85 g (147 mmol) of sulforhodamine B acid chloride is added thereto, and the mixture is agitated. Subsequently, 16.1 g (177 mmol) of serinol, 0.899 g (7.37 mmol) of N,N-dimethylamino pyridine, and 38.3 g (53 ml, 295 mmol) of triethyl amine are further added thereto, and the mixture is agitated at room temperature for 15 hours. Then, the mixture is concentrated under a reduced pressure by using a rotary evaporator to obtain a red solid, and the red solid is rinsed with ethylacetate, obtaining 70.1.5 g of a solid compound represented by the following Chemical Formula 6-4 (a yield of 69%).

### [NMR Data]

¹H NMR (300 MHz, CD3OD): δ=8.67 (s, 1H), 8.16 (d, 1H), 7.58 (d, 1H), 7.13-6.92 (m, 6H), 4.2 (t, 1H), 3.73-3.66 (m, 8H), 3.50-2.95 (m, 5H), 1.42-1.17 (m, 12H)

### (Polymer Synthesis)

### Acrylic Polymer

### Synthesis Example 13

### Synthesis Method of Acrylic Polymer and Molecular Weight

100 ml of methylethylketone is put in a flask after a stir bar is put in the flask, 3 g (4.6 mmol) of the solid represented by the above Chemical Formula 3-1, 7 g (37.9 mmol) of 2-ethylhexyl acrylate, and 0.3 g (1.8 mmol) of azobisisobutyronitrile are added thereto under a nitrogen stream, and the mixture is agitated, obtaining at 80° C. for 15 hours, obtaining a copolymer.

Average molecular weight reduced to polystyrene: number average molecular weight (Mn)=2,100, weight average molecular weight (Mw)=3,000

### Urea Polymer

### Synthesis Example 14

### Synthesis Method of Urea Polymer and Molecular Weight

100 ml of methylethylketone is put in a flask after a stir bar is put in the flask, 6.7 g (40 mmol) of hexamethylene diisocyanate, 3.5 g (30 mmol) of 1,6-hexanediol, and 0.01 g (0.02 mmol) of dibutyltin dilaurate are added thereto under a nitrogen stream, and the mixture is agitated at 80° C. for 15 hours. Subsequently, 10.9 g (20 mmol) of the solid represented by the above Chemical Formula 4-1 is added to the mixture, and the resulting mixture is agitated at 80° C. for 1 hour, obtaining a copolymer.

Average molecular weight reduced to polystyrene: number average molecular weight (Mn)=2,100, weight average molecular weight (Mw)=3,400

### Urethane Polymer

### Synthesis Example 15

### Synthesis Method of Urethane Polymer and Molecular Weight

100 ml of methylethylketone is put in a flask after putting a stir bar therein, 5.0 g (30 mmol) of hexamethylene diisocyanate, 4.7 g (40 mmol) of 1,6-hexanediol, and 0.01 g (0.02 mmol) of dibutyltin dilaurate are added thereto, and the mixture is agitated at 80° C. for 15 hours. Subsequently, 12.2 g (20 mmol) of the solid represented by the above Chemical Formula 5-1 is added to the mixture, and the resulting mixture is agitated at 80° C. for 1 hour, obtaining a copolymer.

Average molecular weight reduced to polystyrene: number average molecular weight (Mn)=2,200, weight average molecular weight (Mw)=3,300

### Evaluation 1: Solubility

0.5 g of each compound represented by Chemical Formulae 3-1 and 7-1 is respectively added to a dilution solvent (PGMEA, Anone, MeOH) to prepare each solution, the solution is agitated at 25° C. and 100 rpm for 1 hour with a mix rotor (MIXROTAR VMR-5, Luchi Deiseido Co., Ltd.) to examine dissolution state of the compound (the content of the dissolved compound), and the results are provided in the following Table 1. (Anone indicates cyclohexanone)

TABLE 1

| Amount of dissolved compound (wt %) | | | |
|---|---|---|---|
| diluted solvent | diluted solvent | diluted solvent | |
| (PGMEA) | (Anone) | (MeOH) | Compound |
| less than or equal | less than or | 0.1 to 0.5 | Chemical |
| to 0.1 | equal to 0.1 | | Formula 3-1 |
| 0.1 | 3.0 | greater than or | Chemical |
| | | equal to 10.0 | Formula 7-1 |

### Evaluation 2: Transmittance

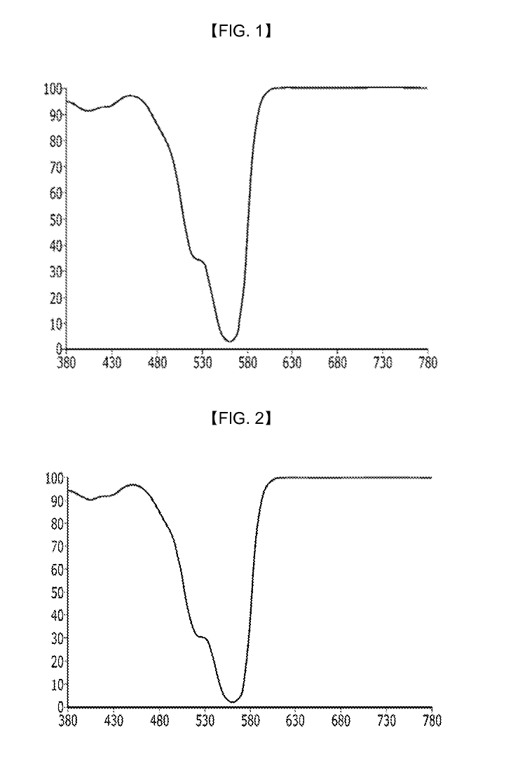

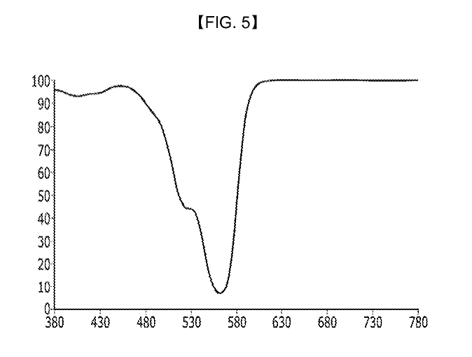

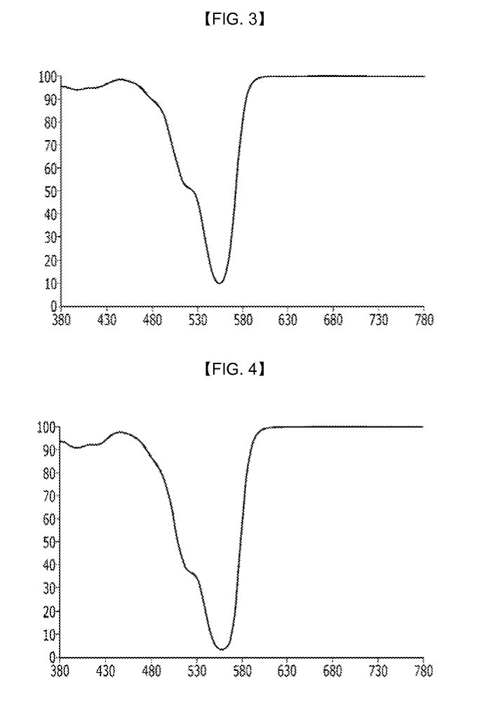

Transmittance is measured by preparing by respectively diluting the compounds represented by Chemical Formulae 3-1, 6-3, 7-1, 7-2 and 8-1 in a concentration of 0.001 wt % in cyclohexanol in a 10.00 mm-thick quartz cell and using a UV/VIS Spectrophotometer:UV-1800 (SHIMADZU Corp.) at a wavelength of 200 nm to 800 nm, and the results are provided in FIGS. 1 to 5.

Referring to Table 1 and FIGS. 1 to 5, the compound of the present invention exhibits excellent solubility and spectrum characteristics.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A compound represented by the following Chemical Formula 1: 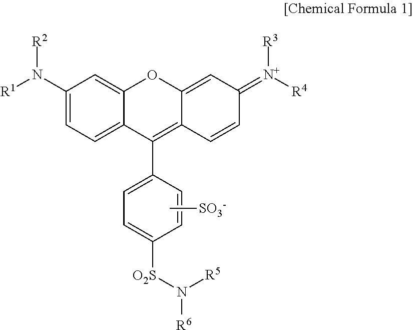
wherein, in the above Chemical Formula 1,
R¹ to R⁴ are the same or different and are each independently hydrogen, substituted or unsubstituted C1 to C20 alkyl, substituted or unsubstituted C6 to C20 aryl, or a combination thereof, and
R⁵ and R⁶ are the same or different and are each independently hydrogen or represented by the following Chemical Formula 2,
*-LX—Y—Z)ₙ [Chemical Formula 2]
wherein, in the above Chemical Formula 2,
L is a single bond, a divalent or trivalent aliphatic organic group, or a divalent or trivalent alicyclic organic group,
X is a single bond, substituted or unsubstituted C1 to C20 alkylene, substituted or unsubstituted C3 to C20 cycloalkylene, or substituted or unsubstituted C6 to C20 arylene,
Y is a single bond, —O—, —C(═O)—, —C(═O)R′—, —OR″—, —R″O— or —OC(═O)NHR′″—, wherein R′ to R′″ are the same or different and are each independently substituted or unsubstituted C1 to C20 alkylene, substituted or unsubstituted C3 to C20 cycloalkylene, or substituted or unsubstituted C6 to C20 arylene,
Z is a substituted or unsubstituted acrylate group, a substituted or unsubstituted amine group, an isocyanate group, a hydroxy group, substituted or unsubstituted C1 to C20 alkyl or —OC(═O)R″″, wherein the R″″ is substituted or unsubstituted C1 to C20 alkyl, and
n is an integer of 1 or 2.

2. The compound of claim 1, wherein R⁵ and R⁶ are both represented by Chemical Formula 2.

3. The compound of claim 1, wherein Chemical Formula 2 is represented by one or more of the following Chemical Formula 3 to Chemical Formula 6: 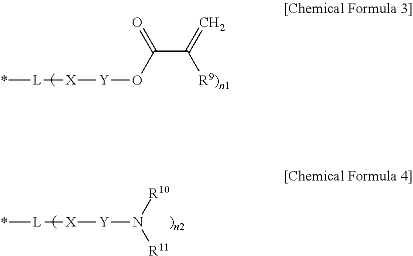
*-LX—Y—NCO)ₙ₃ [Chemical Formula 5]
*-LX—Y—OH)ₙ₄ [Chemical Formula 6]
wherein, in the above Chemical Formula 3 to Chemical Formula 6,
L is a single bond, a divalent or trivalent aliphatic organic group, or a divalent or trivalent alicyclic organic group,
X is a single bond, substituted or unsubstituted C1 to C20 alkylene, substituted or unsubstituted C3 to C20 cycloalkylene, or substituted or unsubstituted C6 to C20 arylene,
Y is a single bond, —OR″—, —R″O— or —OC(═O)NHR′″—, wherein R″ and R′″ are the same or different and are each independently substituted or unsubstituted C1 to C20 alkylene, substituted or unsubstituted C3 to C20 cycloalkylene, or substituted or unsubstituted C6 to C20 arylene,
R⁹ to R¹¹ are the same or different and are each independently hydrogen or substituted or unsubstituted C1 to C20 alkyl, and
n1 to n4 are the same or different and are each independently integers of 1 or 2.

4. The compound of claim 1, wherein Chemical Formula 2 is represented by one or more of the following Chemical Formula 7 to Chemical Formula 10:
*-L(CH₂)ₘ₁—CH₃)ₙ₅ [Chemical Formula 7] 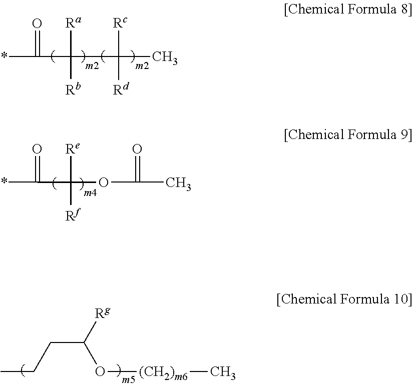
wherein, in the above Chemical Formula 7 to Chemical Formula 10,
L is a single bond, a divalent or trivalent aliphatic organic group, or a divalent or trivalent alicyclic organic group,
R^{a} to R^{g} are the same or different and are each independently hydrogen or substituted or unsubstituted C1 to C20 alkyl,
n5 is an integer of 1 or 2,
m1 to m4, and m6 are the same or different and are each independently integers ranging from 0 to 15, and
m5 is an integer ranging from 1 to 5.

5. A polymer formed by a copolymerization reaction of the compound of claim 1 and a monomer.

6. The polymer of claim 5, wherein the monomer comprises an ethylenic unsaturated monomer, an isocyanate monomer, an alcohol monomer, or a combination thereof.

7. The polymer of claim 6, wherein the ethylenic unsaturated monomer comprises an aromatic vinyl compound, an unsaturated carboxylate ester compound, an unsaturated amino alkyl carboxylate ester compound, a vinyl carboxylate ester compound, an unsaturated carboxylic acid glycidyl ester compound, a vinyl cyanide compound, an unsaturated amide compound, or a combination thereof.

8. The polymer of claim 5, wherein the polymer is an acrylic polymer, and
the acrylic polymer is formed by a copolymerization reaction of a compound represented by the following Chemical Formula 1 and an ethylenic unsaturated monomer: 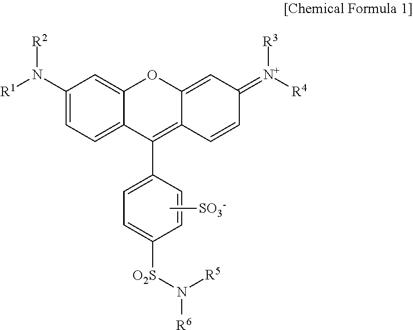
wherein, in the above Chemical Formula 1,
R¹ to R⁴ are the same or different and are each independently hydrogen, substituted or unsubstituted C1 to C20 alkyl, substituted or unsubstituted C6 to C20 aryl, or a combination thereof, and
R⁵ and R⁶ are the same or different and are each independently hydrogen or represented by the following Chemical Formula 3, provided that at least one of R⁵ and R⁶ is represented by the following Chemical Formula 3, 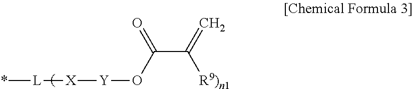
wherein, in the above Chemical Formula 3,
L is a single bond, a divalent or trivalent aliphatic organic group, or a divalent or trivalent alicyclic organic group,
X is a single bond, substituted or unsubstituted C1 to C20 alkylene or substituted or unsubstituted C3 to C20 cycloalkylene,
Y is a single bond, —OR″— or —OC(═O)NHR′″—, wherein R″ and R′″ are the same or different and are each independently substituted or unsubstituted C1 to C20 alkylene or substituted or unsubstituted C3 to C20 cycloalkylene,
R⁹ is hydrogen or substituted or unsubstituted C1 to C20 alkyl, and
n1 is an integer of 1 or 2.

9. The polymer of claim 5, wherein the polymer is an urea polymer, and
the urea polymer is formed by a copolymerization reaction of a compound represented by the following Chemical Formula 1 and an isocyanate monomer: 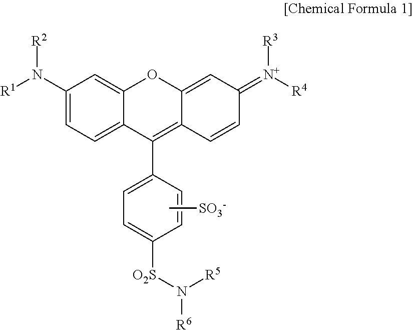
wherein, in the above Chemical Formula 1,
R¹ to R⁴ are the same or different and are each independently hydrogen, substituted or unsubstituted C1 to C20 alkyl, substituted or unsubstituted C6 to C20 aryl, or a combination thereof, and
R⁵ and R⁶ are the same or different and are each independently hydrogen or represented by the following Chemical Formula 4, provided that at least one of R⁵ and R⁶ is represented by the following Chemical Formula 4, 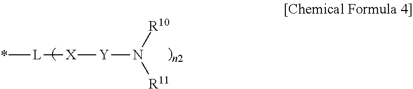
wherein, in the above Chemical Formula 4,
L is a single bond, a divalent or trivalent aliphatic organic group, or a divalent or trivalent alicyclic organic group,
X is a single bond, substituted or unsubstituted C1 to C20 alkylene or substituted or unsubstituted C3 to C20 cycloalkylene,
Y is a single bond, —OR″— or —OC(═O)NHR′″—, wherein R″ and R′″ are the same or different and are each independently substituted or unsubstituted C1 to C20 alkylene or substituted or unsubstituted C3 to C20 cycloalkylene,
R¹⁰ and R¹¹ are the same or different and are each independently hydrogen or substituted or unsubstituted C1 to C20 alkyl, and
n2 is an integer of 1 or 2.

10. The polymer of claim 5, wherein the polymer is an urethane polymer, and
the urethane polymer is formed by a copolymerization reaction of a compound represented by the following Chemical Formula 1 and an alcohol monomer: 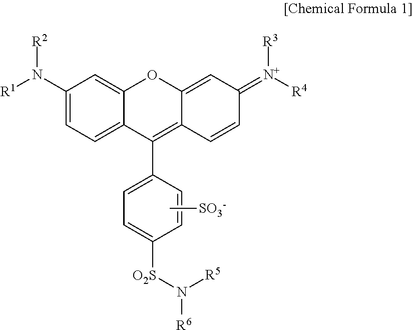
wherein, in the above Chemical Formula 1,
R¹ to R⁴ are the same or different and are each independently hydrogen, substituted or unsubstituted C1 to C20 alkyl, substituted or unsubstituted C6 to C20 aryl, or a combination thereof,
R⁵ and R⁶ are the same or different and are each independently hydrogen or represented by the following Chemical Formula 5, provided that at least one of R⁵ and R⁶ is represented by the following Chemical Formula 5,
*-LX—Y—NCO)ₙ₃ [Chemical Formula 5]
wherein, in the above Chemical Formula 5,
L is a single bond, a divalent or trivalent aliphatic organic group, or a divalent or trivalent alicyclic organic group,
X is a single bond, substituted or unsubstituted C1 to C20 alkylene or substituted or unsubstituted C3 to C20 cycloalkylene,
Y is a single bond, —OR″— or —OC(═O)NHR′″—, wherein R″ and R′″ are the same or different and are each independently substituted or unsubstituted C1 to C20 alkylene or substituted or unsubstituted C3 to C20 cycloalkylene, and
n3 is an integer of 1 or 2.

11. The polymer of claim 5, wherein the polymer is an urethane polymer, and
the urethane polymer is formed by a copolymerization reaction of a compound represented by the following Chemical Formula 1 and an isocyanate monomer: 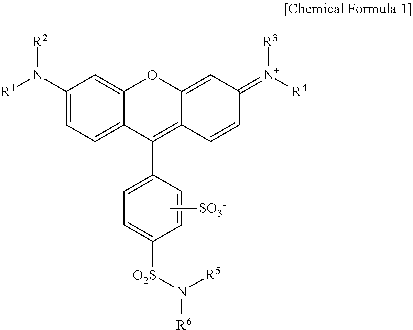
wherein, in the above Chemical Formula 1,
R¹ to R⁴ are the same or different and are each independently hydrogen, substituted or unsubstituted C1 to C20 alkyl, substituted or unsubstituted C6 to C20 aryl, or a combination thereof, and
R⁵ and R⁶ are the same or different and are each independently hydrogen or represented by the following Chemical Formula 6, provided that at least one of R⁵ and R⁶ is represented by the following Chemical Formula 6,
*-LX—Y—OH)ₙ₄ [Chemical Formula 6]
wherein, in the above Chemical Formula 6,
L is a single bond, a divalent or trivalent aliphatic organic group, or a divalent or trivalent alicyclic organic group,
X is a single bond, substituted or unsubstituted C1 to C20 alkylene or substituted or unsubstituted C3 to C20 cycloalkylene,
Y is a single bond, —OR″— or —OC(═O)NHR′″—, wherein R″ and R′″ are the same or different and are each independently substituted or unsubstituted C1 to C20 alkylene or substituted or unsubstituted C3 to C20 cycloalkylene, and
n4 is an integer of 1 or 2.

12. A colorant comprising the compound of claim 1.

13. A photosensitive resin composition comprising the colorant of claim 12.

14. The photosensitive resin composition of claim 13, wherein the photosensitive resin composition further comprises a binder resin, a photopolymerizable monomer, a photopolymerization initiator, and a solvent.

15. A color filter manufactured from the photosensitive resin composition of claim 14.

16. A colorant comprising a polymer of claim 5.
